(19) United States
(12) Patent Application Publication
(10) Pub. No.: US 2011/0084217 A1
(43) Pub. Date: Apr. 14, 2011

(54) SUPERCONTINUUM LASER SOURCE FOR FULL-FIELD CONFOCAL MICROSCOPY, SPIM AND TIRF

(75) Inventor: Glen Ivan Redford, Arvada, CO (US)

(73) Assignee: INTELLIGENT IMAGING INNOVATIONS, INC., Denver, CO (US)

(21) Appl. No.: 12/902,749

(22) Filed: Oct. 12, 2010

Related U.S. Application Data
(60) Provisional application No. 61/251,069, filed on Oct. 13, 2009.

(51) Int. Cl. G01J 1/58; G02B 21/06

(52) U.S. Cl. 250/458.1; 359/385

(57) ABSTRACT

A supercontinuum laser is used as the excitation source for full-field confocal, SPIM or TIRF imaging. A supercontinuum laser will allow the use of any wavelength desired for excitation without having to buy additional lasers. The wavelength can be easily selected using an acousto-optical device. Also disclosed is a means for driving an acousto-optical device such that an arbitrary wavelength window can be selected—this allows for the broader wavelength ranges that will give the increased power needed for full-field confocal, SPIM or TIRF imaging.

### RELATED APPLICATION DATA

This application claims the benefit of and priority under 35 U.S.C. §119(e) to U.S. patent application Ser. No. 61/251,069, filed Oct. 13, 2009, entitled “Supercontinuum Laser Source For Full-Field Confocal Microscopy And TIRF,” which is incorporated herein by reference in its entirety.

### FIELD

An exemplary aspect of this invention generally relates to laser based excitation for fluorescence in optical microscopes. More specifically, an exemplary embodiment of this invention applies to full-field optical sectioning techniques. More specifically, an exemplary embodiment of this invention relates to full-field confocal, SPIM (Single Plane Illumination Microscopy) and TIRF (Total Internal Reflection Fluorescence) microscopy. Even more specifically, an exemplary embodiment of the invention relates to using a supercontinuum laser as an excitation source for full-field confocal, SPIM and/or TIRF microscopy. Even more specifically, an exemplary embodiment of the invention relates to an ideal acousto-optical device for selecting an arbitrary wavelength band from a supercontinuum laser for full-field optical sectioning microscopy.

### BACKGROUND

A popular technique for fluorescence microscopy is full-field confocal microscopy. This technique which includes spinning disk, slit-scanning, pinhole-scanning and other devices allows confocal optical sectioning while imaging with a two-dimensional sensor array (that is, a camera or CCD). This technique allows faster and often cheaper confocal imaging when compared to scanning-confocal systems. Many full-field confocal systems use a laser as the excitation source for fluorescence imaging. To perform multi-channel, spectrally separate imaging with lasers, multiple lasers need to be combined and switched between. Because a full-field confocal system is typically fast, switching between laser excitation lines also needs to be fast. This allows better time resolution for multi-channel experiments.

Laser systems that combine multiple lasers to enable multiple excitation wavelengths can be large, expensive, and complicated. Even then, such systems are only able to provide excitation light at the specific wavelengths of the constituent lasers. New supercontinuum lasers are relatively small, compact, and provide a broad excitation wavelength source. This means that they are effectively a combination of a nearly infinite number of lasers all in one source. To use a supercontinuum laser in a full-field confocal system would require a method for selecting a specific wavelength band (or bands) to inject into the confocal system, excluding the other wavelengths. This can be accomplished by several different means. An ideal way to do this would be to use an acousto-optical device that can select an arbitrary band from the broad spectrum laser.

Total internal reflection fluorescence (TIRF) usually requires a laser source as the excitation light. For microscopy, it is beneficial to have multiple excitation wavelengths that can be rapidly switched between. As for full-field confocal, TIRF can use a combined laser system, but would benefit from a supercontinuum laser source for arbitrary excitation wavelength selection.

Single Plane Illumination Microscopy (SPIM) also usually requires a laser source and would also benefit from supercontinuum lasers.

All of the above techniques can be broadly categorized as full-field (as opposed to scanning) optical sectioning techniques.

### SUMMARY

Supercontinuum lasers are now available with the appropriate power levels needed for full-field confocal and TIRF microscopy. Both of these techniques require much higher power levels than scanning confocal or similar techniques. It is anticipated that supercontinuum lasers will continue to increase in power and continue to be more useful for full-field techniques in the future.

A supercontinuum laser is a broad spectrum laser such that the power of the laser is spread more or less evenly over a large range of wavelengths. Of particular interest for microscopy are supercontinuum lasers with visible wavelength outputs. These lasers are often referred to as “white lasers” because of the broad spectrum output. For fluorescence, only a narrow band of wavelengths is desired as an excitation source. Most fluorescence probes have an excitation range of only a few tens of nanometers. Excitation wavelengths outside of this range are undesirable for fluorescence. Therefore, to use a supercontinuum laser for fluorescence, it is imperative that some means be used to select only the desired range of wavelengths from the broad spectrum coming from the laser.

A exemplary useful means for selecting the wavelengths from a supercontinuum laser includes an acousto-optical device. These devices can be “tuned” by applying high frequency voltages to them, such that a narrow band of wavelengths that are transmitted through the device are diverted to another beam. This diverted beam is then coupled into the full-field confocal or TIRF device. With appropriate control electronics, the selected wavelength can be rapidly switched. One large problem is that the bandwidth of the acousto-optical devices is such that the deflected wavelength is very narrow (typically ˜1 nm). Supercontinuum lasers are rated by power per nanometer, and so such a narrow wavelength spectrum will have low power. Ideally, the acousto-optical device will have electronic control such that any arbitrary window of the visible spectrum can be used (meaning an arbitrary center wavelength with an arbitrary width of wavelengths).

Currently, supercontinuum lasers do not readily provide light with wavelengths in the purple visible region of the spectrum or in the UV spectrum. Additional conventional lasers can be combined with the supercontinuum laser to provide power in those spectral regions.

Most common acousto-optical devices use a simple RF frequency generator chip in their electronics. Many devices have multiple single frequency generators, such that more than one frequency can be generated at a time. One method for increasing the wavelength window is to combine multiple frequency generators such that their outputs are close and will sum up their respective narrow windows to approximate a larger window. There are problems inherent to using this method however, one of which being that a single window will require the resources of many of the generators, meaning that there is a limited number of windows that can be rapidly switched between.

One exemplary driver for an acousto-optical device would use a waveform generator. Then any arbitrary multi-frequency waveform could be used. For example, a waveform with a broad Gaussian-like distribution in frequency space would make a broad wavelength window. In this manner, the window could easily be made to any arbitrary shape. Multiple wavelength patterns could be stored in memory of the waveform generator, and the patterns could be rapidly switched between. This would make for an ideal device such that any arbitrary window of wavelengths could be obtained from the supercontinuum laser. The windows could be rapidly switched between which would facilitate fast and flexible full-field confocal or TIRF imaging.

In accordance with an exemplary embodiment of this invention, a supercontinuum laser is used as an excitation source for a full-field confocal device for microscopy.

In accordance with another exemplary embodiment, a supercontinuum laser is used for TIRF imaging.

In accordance with another exemplary embodiment, a supercontinuum laser is used for SPIM.

The exemplary apparatus can comprise:
a full-field confocal imaging device for a microscope, a SPIM or a TIRF device for a microscope;
a supercontinuum laser as an excitation source; and
a means for selecting a specific window or windows of wavelengths from the broad wavelength source.

This apparatus when combined with an optical microscope and an imaging device would provide a way for confocal microscopy, SPIM or TIRF.

The exemplary device has one exemplary advantage that any desired excitation wavelength can be used without need to buy a new laser.

Aspects of the invention are thus directed toward laser-based excitation for fluorescence in optical microscopes.

Still further aspects of the invention are directed toward full-field optical sectioning techniques.

Still further aspects of the invention are directed toward full-field confocal, SPIM and TIRF microscopy.

Even further aspects of the invention are directed toward using a supercontinuum laser as an excitation source for full-field confocal, SPIM and TIRF microscopy.

Still further aspects of the invention are directed toward an ideal acousto-optical device for selecting an arbitrary wavelength band from a supercontinuum laser for full-field optical sectioning.

Even further aspects of the invention are directed toward an electronic means for driving an acousto-optical device to provide arbitrary wavelength window selection and switching.

Even further aspects of the invention are directed toward automated control and software for the device.

Still further aspects of the invention relate to an apparatus for full-field confocal, SPIM or TIRF imaging comprising:
a full-field confocal, SPIM or TIRF device;
a supercontinuum laser; and
means for selecting a desired wavelength from the supercontinuum source.

The aspect above, where the full-field confocal device is a spinning-disk confocal.

The aspect above, where the full-field confocal device is a slit-scanning confocal.

The aspect above, where the full-field confocal device scans an array of pinholes over the sample.

The aspect above, where the full-field confocal device is a structured illumination device.

The aspect above, where the TIRF device controls the angle of the excitation light, enabling TIRF.

The aspect above, where the TIRF device allows imaging or integration of multiple angles or a circular angle pattern.

The aspect above, where the laser illumination is confined to a plane normal or near normal to the optical axis of the imaging device (SPIM).

The aspect above, where the wavelength is selected by means of one or more optical filters.

The aspect above, where one or more optical filters are automatically switched to change the wavelength, for example, using a filter wheel.

The aspect above, where the means for selecting the wavelength is an acousto-optical device.

The aspect above, where the acousto-optical device is driven such that individual frequencies are placed next to each other to approximate a broader wavelength window.

The aspect above, where the acousto-optical device is driven using a waveform generator such than any arbitrary window could be used.

The aspect above, where the apparatus is automated and controlled with a computer program, software and/or firmware.

These and other features and advantages of this invention are described and, or are apparent from, the following detailed description of the exemplary embodiment.

### BRIEF DESCRIPTION OF THE DRAWINGS

The exemplary embodiments of the invention will be described in detail, with reference to the following figures wherein:

FIG. 1 illustrates an exemplary embodiment of the invention showing a full-field confocal device.

FIG. 2 illustrates an exemplary embodiment of the invention showing a TIRF device.

FIG. 3 illustrates an exemplary embodiment of the invention showing a SPIM device.

### DETAILED DESCRIPTION

The exemplary embodiments of this invention will be described in relation to microscopes, imaging systems, and associated components. However, it should be appreciated that, in general, known components will not be described in detail. For purposes of explanation, numerous details are set forth in order to provide a thorough understanding of the present invention. It should be appreciated however that the present invention may be practiced in a variety of ways beyond the specific details set forth herein.

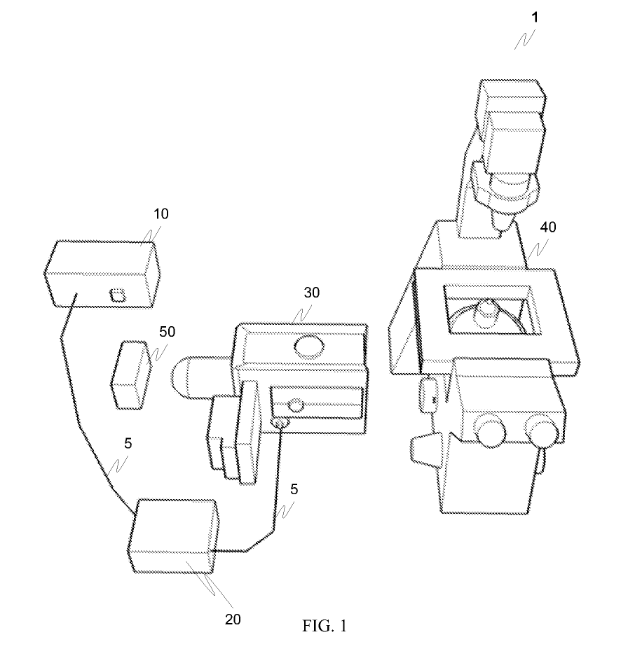

FIG. 1 illustrates an exemplary embodiment using a full-field confocal device 1.

The exemplary full-field confocal device 1 includes a supercontinuum laser 10, a wavelength selection device 20, a spinning-disk confocal 30, a microscope 40 and a camera 50.

The supercontinuum laser 10 is connected via a fiber optic 5 to the wavelength selection device 20. This wavelength selection device could be a filter wheel or acousto-optical device or in general any type(s) of wavelength selection device. The wavelength selection device 20 is connected via a fiber optic 5 to a spinning-disk confocal 30. The confocal device 30 is attached to the microscope 40 and confocal images are capable of being recorded using the camera 50. In practice, full-field confocal devices can be attached to any documentation port (not shown) or illumination port (not shown) on the microscope 40.

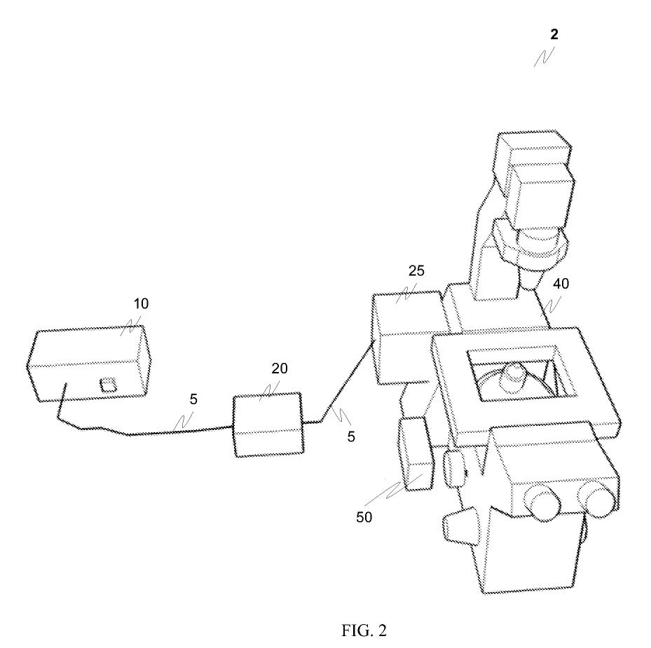

FIG. 2 illustrates an exemplary embodiment of the invention showing a TIRF-based device 2.

The exemplary TIRF-based device 2 includes a supercontinuum laser 10, a wavelength selection device 20, a TIRF device 25, a microscope 40 and a camera 50.

The supercontinuum laser 10 is connected via a fiber optic 5 to the wavelength selection device 20. The wavelength selection device 20 is connected via a fiber optic 5 to the TIRF device 25. The TIRF device 25 is attached to the microscope 40 and the images are recorded using a camera 50.

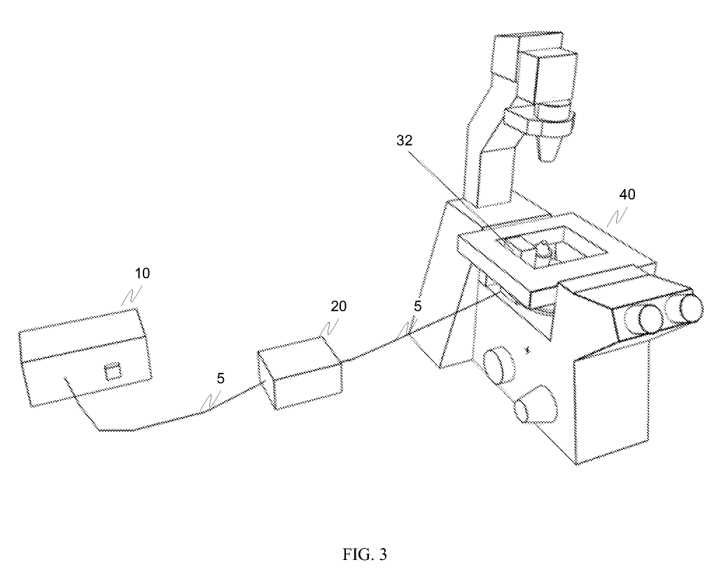

FIG. 3 illustrates an exemplary embodiment of this invention using a SPIM device. The SPIM-type device includes a supercontinuum laser 10, a wavelength selection device 20, a SPIM illuminator 32 and a microscope 40.

The supercontinuum laser 10 is connected via a fiber optic 5 to the wavelength selection device 20. The wavelength selection device 20 is connected via a fiber optic 5 to the SPIM illuminator 32, which illuminates a single plane a fixed distance from the objective on the microscope 40.

As mentioned, Single Plane Illumination Microscopy (SPIM) also usually requires a laser source and would also benefit from supercontinuum lasers. Full-field confocal, SPIM and TIRF methods fall under the general category of full-field optical sectioning techniques. This is in contrast with scanning techniques such as scanning confocal and multiple photon imaging. These techniques use structured illumination to either only illuminate the focal plane of interest or optically or computationally eliminate the out of focus light. Computational means of eliminating the out of focus light include structured illumination that only illuminates part of the image with the illumination pattern having maximum high frequency content. Then another image is taken with the illumination changed so that there is no overlap of the illumination patterns. This process can repeat several times. The resultant images can be subtracted or subjected to other computer-based image processing techniques and/or algorithms to calculate the out of focus light and remove it from the image.

The exemplary techniques illustrated herein are not limited to the specifically illustrated embodiments but can also be utilized with the other exemplary embodiments and each described feature is individually and separately claimable.

The systems of this invention also can cooperate and interface with a special purpose computer, a general purpose computer including a controller/processor and memory/storage, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. The term module as used herein can refer to any known or later developed hardware, software, firmware, or combination thereof, that is capable of performing the functionality associated with that element. The terms determine, calculate, and compute and variations thereof, as used herein are used interchangeable and include any type of methodology, process, technique, mathematical operational or protocol.

Furthermore, the disclosed system may use control methods and graphical user interfaces that may be readily implemented in software using object or object-oriented software development environments that provide portable source code that can be used on a variety of computer or workstation platforms that include a processor and memory. Alternatively, the disclosed control methods may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

It is therefore apparent that there has been provided, in accordance with the present invention microscopy-type devices. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A confocal imaging device comprising:
a full-field confocal imaging device; and
a supercontinuum laser adapted to provide excitation light.

2. A TIRF (Total Internal Reflection Fluorescence) imaging device comprising:
a laser TIRF device; and
a supercontinuum laser adapted to provide excitation light.

3. The system of claim 1, wherein the full-field confocal imaging device is a spinning-disk confocal.

4. The system of claim 1, wherein the full-field confocal imaging device is a slit-scanning confocal.

5. The system of claim 1, wherein the full-field confocal imaging device scans an array of pinholes over a sample.

6. The system of claim 2, wherein the TIRF imaging device controls a laser angle.

7. The system of claim 2, wherein the TIRF imaging device is adapted to allow multiple laser angles or a circular pattern of laser angles to be integrated in a TIRF image.

8. A SPIM (Single Plane Illumination Microscopy) device comprising:
a single plane illumination optics and imaging device; and
a supercontinuum laser adapted to provide excitation light.

9. The system of claim 1, further comprising a means to select used wavelengths from the supercontinuum laser.

10. The system of claim 2, further comprising a means to select used wavelengths from the supercontinuum laser.

11. The system of claim 9, wherein the wavelength selection is done by optical filters.

12. The system of claim 10, wherein the wavelength selection is done by optical filters.

13. The system of claim 11, wherein the optical filters are in a filter wheel.

14. The system of claim 12, wherein the optical filters are in a filter wheel.

15. The system of claim 9, wherein the wavelength selection is done by an acousto-optical device.

16. The system of claim 10, wherein the wavelength selection is done by an acousto-optical device.

17. The system of claim 15, wherein the acouto-optical device is driven by a waveform generator such that an arbitrary wavelength window can be chosen.

18. The system of claim 16, wherein the acouto-optical device is driven by a waveform generator such that an arbitrary wavelength window can be chosen.

19. The system of claim 9, wherein the wavelengths can be rapidly switched and synchronized to other hardware.

20. The system of claim 10, wherein the wavelengths can be rapidly switched and synchronized to other hardware.

21. The system of claim 19, wherein the hardware is a camera.

22. The system of claim 20, wherein the hardware is a camera.

23. The system of claim 17, wherein the waveform used has a broad spectrum in frequency space.

24. The system of claim 18, wherein the waveform used has a broad spectrum in frequency space.

25. The system of claim 23, wherein the broad spectrum in frequency space is a wide Gaussian.

26. The system of claim 23, wherein the broad spectrum in frequency space is a wide Gaussian.

27. The system of claim 1, wherein the full-field confocal imaging device further comprises a structured illumination scheme where different parts of an image are illuminated and resultant images are used in a computation to calculate a confocal image.

28. The system of claim 3, wherein an image transmitted through the spinning disk and an image reflected off the spinning disk are combined to calculate a confocal image.
